(19) United States
(12) Patent Application Publication
(10) Pub. No.: US 2018/0099410 A1
(43) Pub. Date: Apr. 12, 2018

(54) ROBOT CONTROL DEVICE HAVING FUNCTION FOR LIMITING SPEED AND/OR ACCELERATION OF ROBOT

(71) Applicant: FANUC CORPORATION, Yamanashi (JP)

(72) Inventor: Tsuyoshi HANNYA, Yamanashi (JP)

(21) Appl. No.: 15/725,425

(22) Filed: Oct. 5, 2017

(30) Foreign Application Priority Data
Oct. 12, 2016 (JP) 2016-200912

(51) Int. Cl. B25J 9/16

(52) U.S. Cl. CPC B25J 9/1651; Y10S 901/09; B25J 9/1674

(57) ABSTRACT

A robot control device includes: a robot tool tip position calculator configured to calculate a position of a tip part of a tool of a robot; an operation limited region setting unit provided for a user to set an operation limited region having a desired size; a determination unit configured to determine whether or not the position of the tip part of the tool is within the operation limited region; and an operation limiting unit configured to, in the case where the position of the tip part of the tool is within the operation limited region, limit at least one of a speed and an acceleration of the robot.

### BACKGROUND OF THE INVENTION

### 1. Field of the Invention

The present invention relates to a robot control device controlling an industrial robot installed at a production site.

### 2. Description of the Related Art

When an industrial robot is used at a production site, a user creates a program including operation commands for the robot in advance and stores the program in a robot control device. Alternatively, the user uses a teach pendant or the like connected to the robot control device to actually operate the robot and teach the robot operations for tasks. When operations for a robot are set in such a manner, the user will typically determine the speed and/or acceleration required for the application of the robot, using the maximum speed and/or maximum acceleration that can be achieved by the robot as upper limits.

However, if the robot interferes with nearby machines due to programming errors or operating errors, those nearby machines may sustain significant damage if the robot is moving at the maximum speed or maximum acceleration.

In the related art, a method that sets parameters pertaining to operation limits for the robot so as to limit the maximum speed and/or maximum acceleration the robot can achieve has been used in order to reduce damage at such times of interference (called a “first related art example” hereinafter). For the similar purpose, there is also a method that provides a robot control device with a switch for changing an operating mode of a robot to a teaching mode, where in the teaching mode, teaching operations can be made to the robot while limiting the operation speed of the robot to a predetermined safe speed (called a “second related art example” hereinafter).

Methods that limit the operation speed of a robot are also disclosed by the following patent documents.

Namely, JP-A-2015-208789 discloses a device that uses a sensor installed in a robot to detect environment information of the surroundings of the robot, and generates a three-dimensional environment model including an unobserved region not detectable by the sensor and an operating environment of the robot on the basis of that environment information. This device includes a function for limiting the operation speed, operation acceleration, operation force, and the like upon determining that the robot has entered the unobserved region.

JP-A-2015-000470 discloses a robot control device in which a safe distance is set between a robot and a human. In accordance with the determination that in an emergency shutdown, the robot will be unable to stop before exceeding the safe distance, the operation speed of the robot is limited so that the robot can stop.

JP-A-2011-125975 discloses a device including an entry detector that detects a position of an object entering a predetermined range in which a robot arm is present, and an operation detector that detects a position, a movement direction, and a movement speed of the tip of the robot arm. This device has a function that limits the operation speed of the robot arm in accordance with a distance between the object and the tip of the robot arm, or the movement direction of the tip of the robot arm with respect to the object. The operation of the robot arm is limited in the case where the robot arm is moving toward a person or an object and the robot arm is present within a predetermined separation distance from the person or the object. However, the operation of the robot arm continues without being limited in the case where the robot arm is moving away from the person or the object.

### SUMMARY OF THE INVENTION

However, limiting the maximum speed and/or maximum acceleration of the robot that can be achieved by setting parameters as disclosed in the above-described first related art example also limits the maximum speed and/or maximum acceleration of the robot in operation regions where speed limit is unnecessary, such as operation regions where interference is unlikely. This increases the cycle time of the manufacturing process for which the robot is used.

Likewise, limiting the maximum speed and/or maximum acceleration of the robot that can be achieved by switching the operating mode of the robot to the teaching mode as disclosed in the above-described second related art example also limits the maximum speed and/or maximum acceleration of the robot in operation regions where speed limit is unnecessary. As a result, the efficiency of the robot teaching task worsens. There is also an additional problem in that the speed limit can be applied only during the teaching mode, and the speed limit cannot be applied during production by the robot.

Furthermore, according to the device disclosed in JP-A-2015-208789, in order to limit the operation speed of the robot, it is necessary to detect the environment information of the surroundings of the robot using sensors and generate the three-dimensional environment model including the unobserved region not detectable by the sensors on the basis of that environment information. Accordingly, it is necessary to carry out computational processes for generating the three-dimensional environment model each time control of robot operations is started.

Meanwhile, the device disclosed in the above-described JP-A-2015-000470 is configured to limit the operation speed of the robot in accordance with the determination that in an emergency shutdown, the robot will be unable to stop before exceeding the safe distance. With this device, the conditions for determining whether or not to limit the operation speed of the robot are complicated.

In the case of the device disclosed in the above-described JP-A-2011-125975, it is necessary to detect the distance between the object and the tip of the robot arm, or the movement direction of the tip of the robot arm with respect to the object in order to determine whether or not to limit the speed of the robot arm, complicating the control for limiting the operations.

Thus, in light of the above-described circumstances, an object of the present invention is to provide a robot control device that avoids reducing the speed and/or acceleration of a robot in operation regions where speed limit is unnecessary, but that can limit the speed and/or acceleration of a robot entering a designated region, regardless of the whether the robot is being taught or is in the process of manufacturing.

In order to achieve the above-described object, one aspect of the present invention provides a robot control device configured to control a robot used in industrial fields, the device including:

a robot tool tip position calculator configured to calculate a position of a tip part of a tool attached to the robot while the robot is operating;

an operation limited region setting unit provided for a user to set an operation limited region having a desired size using coordinate values in a world coordinate system of the robot;

a determination unit configured to determine whether or not a position of the tip part calculated by the robot tool tip position calculator is within the operation limited region set by the operation limited region setting unit; and

an operation limiting unit configured to, in accordance with the determination unit having determined that the position of the tip part is within the operation limited region, limit at least one of a speed and an acceleration of the robot.

Another aspect of the present invention provides the robot control device according to the above-described one aspect, in which the robot is a robot that carries out a task of attaching and removing a workpiece to and from a machine tool, and the operation limited region is a region containing the machine tool.

The objects, features and advantages as described above, and another objects and advantages of the present invention will become more apparent from the following description of the embodiments in connection with the accompanying drawings.

### BRIEF DESCRIPTION OF THE DRAWINGS

FIG. 1 is a function block diagram illustrating a robot control device according to an embodiment.

FIG. 2 is a top view of an arm of a robot operated by the robot control device and an operation limited region according to the embodiment.

FIG. 3 is a flowchart illustrating the flow of robot control carried out by the robot control device according to the embodiment.

### DETAILED DESCRIPTION

An embodiment of the present invention will be described with reference to the drawings as follows. In the referenced drawings, identical constituent elements or functional elements are given identical reference signs. Scales in the drawings are changed as appropriate in order to facilitate understanding. The embodiment illustrated in the drawings is merely one example embodying the present invention, and the present invention is not intended to be limited to the illustrated embodiment.

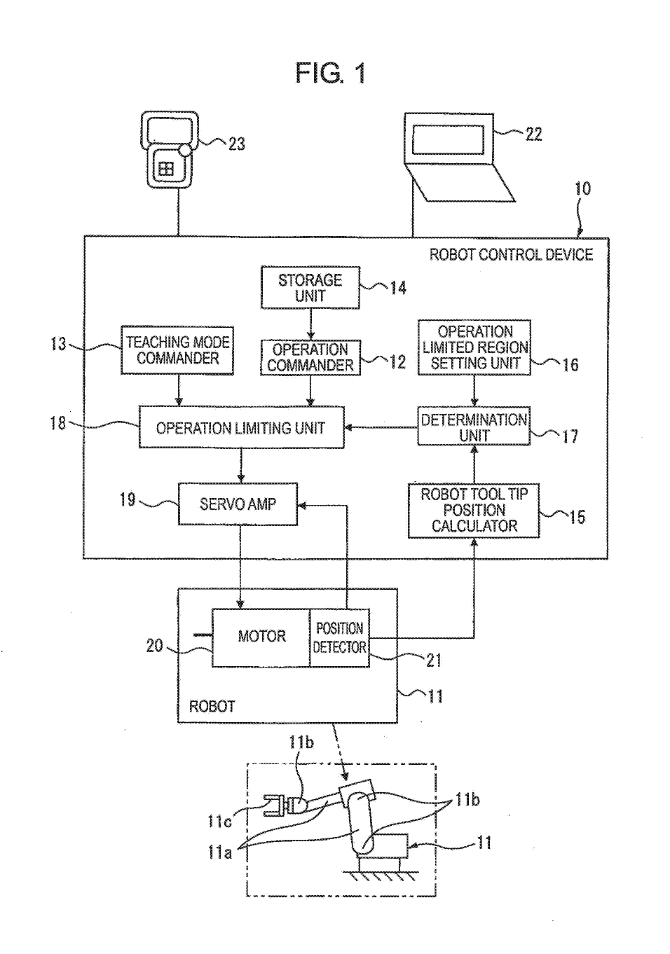

FIG. 1 is a function block diagram illustrating a robot control device 10 according to the embodiment.

As illustrated in FIG. 1, the robot control device 10 according to the present embodiment is intercommunicably connected to an industrial robot 11 in order to control the robot 11.

The robot 11 is an articulated robot in which a plurality of arms (links) 11a are connected by joints 11b, as indicated by the long dashed double-short dashed line in FIG. 1.

One of various types of tools 11c, such as a robot hand, a machine tool, or a welding tool, is removably attached to the joint 11b (also sometimes called a “wrist” hereinafter) located on the end of the most distal arm 11a of the robot 11, so that the robot 11 can carry out tasks. The wrist preferably has a joint structure that enables the tool 11c to be operated in three directions, namely a roll direction, a pitch direction, and a yaw direction.

Each of the joints 11b of the robot 11 includes a motor 20 that rotationally drives the arms 11a. The robot control device 10 is configured to operate each arm 11a by sending operation commands such as speed commands, position commands, and torque commands to the motors 20 in the joints 11b of the robot 11. The robot 11 further includes position detectors 21 such as encoders that detect the axial positions (rotation angles) of the motors 20. The robot control device 10 also includes a servo amp 19 that outputs operation commands to the motors 20 to correct deviation between the actual axial positions of the motors 20 detected by the position detectors 21 and command values.

This application assumes a situation in which various types of peripheral machines or structures such as machine tools or conveyor belts (not illustrated) are installed within a range defined by a rotatable range of the arms 11a of the robot 11. The situation is, for example, one in which the robot 11 is installed at a production site as a loader/unloader that carries out tasks for attaching/removing a workpiece to/from a machine tool. In such a situation, when the robot 11 is operated according to an operation program, a tip part of the tool 11c (called a “tool tip part” hereinafter) attached to the wrist of the robot 11 may interfere with the machine tool if there is programming error. Likewise, when a user operates the robot 11 using a teach pendant 23 in order to teach the robot 11 operations for tasks, the tool tip part of the robot 11 may interfere with the machine tool as a result of operating errors made by the user. At the time of such interference, if the tool tip part is moving at the maximum speed and maximum acceleration that can be achieved by the robot 11, the machine tool will sustain significant damage. In order to reduce such damage, this application enables the user to register a region in which the robot 11 is not moved at a high speed, in other words, an operation limited region A, in the robot control device 10 in advance. The robot control device 10 is furthermore configured to limit the speed and/or acceleration of the robot 11 while the position of the tool tip part is within the operation limited region A.

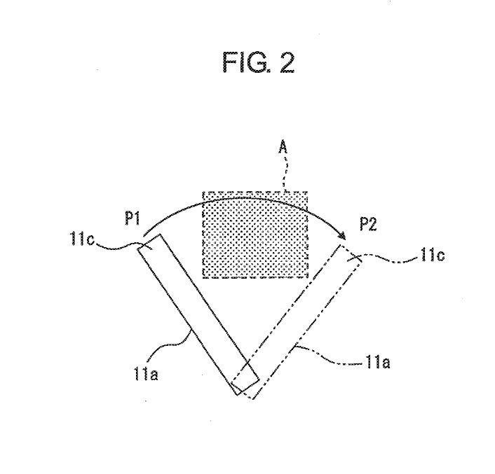

FIG. 2 is a top view of the arm 11a of the robot 11 operated by the robot control device 10 and the operation limited region A according to the embodiment. The arm 11a illustrated in FIG. 2 is assumed to be the most distal arm of the robot 11, to which the tool is attached. Although the operation limited region A is a region that cannot be seen in actual space, the region is indicated by a broken line box in order to facilitate understanding.

As illustrated in FIG. 2, it is assumed that the position of the tool tip part of the robot 11 pivots from a position P1 to a position P2. At this time, the operation of the robot 11 is limited while the tool tip part passes through the operation limited region A indicated by the broken lines. Thus, even if the tool tip part interferes with a machine tool or the like in the operation limited region A, the damage sustained by the machine tool can be kept to a minimum.

Meanwhile, the operation of the robot 11 is limited neither before the tool tip part of the robot 11 enters the operation limited region A nor after the tool tip part has exited the operation limited region A, and the arm 11a of the robot 11 pivots at a speed and acceleration indicated by the operation command. The operating efficiency of the robot 11 can therefore be improved as compared to a method that sets parameters limiting the speed and/or acceleration in advance, or a method of switching to a teaching mode and making teaching operations for the robot while limiting the operations of the robot to a predetermined safe speed.

The operation limited region A is defined, for example, as the inner side of a rectangle, as illustrated in FIG. 2. In this case, the coordinate values of the corners of the rectangle are inputted in numerical values from an operation limited region setting unit 16 and saved in a determination unit 17, which will be described later. These coordinate values are preferably positions in a world coordinate system of the robot 11. The operation limited region A may also be defined as a plurality of regions, and the shape thereof is not limited to a rectangle.

The robot control device 10 according to the above-described embodiment will be described in further detail referring again to FIG. 1.

As illustrated in FIG. 1, the robot control device 10 according to the present embodiment includes an operation commander 12, a teaching mode commander 13, a storage unit 14, a robot tool tip position calculator 15, the operation limited region setting unit 16, the determination unit 17, an operation limiting unit 18, and the servo amp 19. The functions of these constituent elements will be described hereinafter.

The motors 20 driving the axes of the robot 11, which are to be controlled by the robot control device 10, are servo motors.

The operation commander 12 outputs command signals (operation commands) that operate the robot 11 according to a robot operation program created in advance. The robot operation program is stored in the storage unit 14. A user may create the program using a host computer 22 communicably connected to the robot control device 10 and store the program in the storage unit 14. The storage unit 14 is a memory device such as random access memory (RAM), a magnetic storage device such as a hard disk, or the like.

When a signal for operating the robot 11 is inputted into the robot control device 10 by the user using the teach pendant 23, the teaching mode operation commander 12 generates and outputs a command signal (an operation command) based on the inputted signal.

The servo amp 19 has a function of receiving the command signal outputted from the operation commander 12 via the operation limiting unit 18, which will be described later, and then controlling the motors 20 such that the command signal matches output signals from the position detectors 21 that detect the axial positions (rotation angles) of the motors 20. Preferably, encoders are used for the position detectors 21. The servo amp 19 may be provided outside the robot control device 10.

The robot tool tip position calculator 15 has a function of calculating the position of the tip part of the tool 11c attached to the robot 11, or in other words, the position of the tool tip part, while the robot 11 is operating. The calculated position of the tool tip part is assumed to be expressed by coordinate values in the world coordinate system of the robot 11.

The operation limited region setting unit 16 is provided in order for the user to set the operation limited region A having a desired size using coordinate values in the world coordinate system of the robot 11. The operation limited region A is a region, in the real space where the robot 11 is installed, where the robot 11 is not permitted to be operated at high speed. For example, in the case where the robot 11 carries out tasks for attaching/removing a workpiece to/from a machine tool, a region containing that machine tool is set as the operation limited region A.

The operation limited region setting unit 16 may be configured from an input device such as a keyboard or a touch panel attached to the host computer 22 or the teach pendant 23. Coordinate value data of the operation limited region A set using the operation limited region setting unit 16 is sent to and saved in the determination unit 17, described below.

The determination unit 17 has a function of determining whether or not the position of the tool tip part calculated by the robot tool tip position calculator 15 is within the operation limited region A set by the operation limited region setting unit 16.

The operation limiting unit 18 has a function of, in accordance with the determination unit 17 having determined that the position of the tool tip part is within the operation limited region A, limiting at least one of the speed and the acceleration of the robot 11 to no greater than a respective predetermined value. Specifically, while the position of the tool tip part is within the operation limited region A, the operation limiting unit 18 reduces, by a predetermined percentage, only the command values for the speed and acceleration in the operation commands to be outputted to the robot 11. This reduces at least one of the speed and the acceleration of the robot 11 to no greater than a respective predetermined value.

The above-described robot control device 10 may include a display (not illustrated) that displays the operation limited region A of the robot 11 graphically. The display may be constituted of a display panel attached to the host computer 22, a display screen included in the teach pendant 23, or the like. Having such a display makes it possible for a user to set the operation limited region A of the robot 11 while confirming the setting on the display.

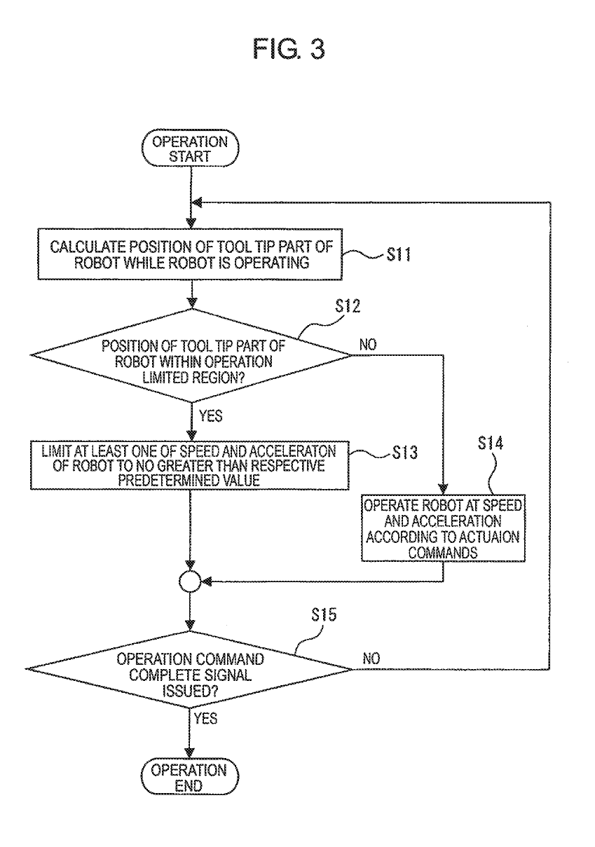

FIG. 3 is a flowchart illustrating the flow of processing of the robot 11, carried out by the robot control device 10 illustrated in FIG. 1.

Operations of the robot control device 10 illustrated in FIG. 1 will be described hereinafter with reference to FIGS. 1 to 3. It is assumed that when step S11 of FIG. 3 is carried out, the operation limited region A has been set by the operation limited region setting unit 16 and inputted to the determination unit 17.

First, in step S11 of FIG. 3, the robot tool tip position calculator 15 of the robot control device 10 calculates the position of the tool tip part of the robot 11 currently operating.

For example, the robot tool tip position calculator 15 reads the axial positions (rotation angles) of the motors 20 in the joints 11b of the robot 11 from the position detectors 21 such as encoders every predetermined amount of time, e.g. every control period. The robot tool tip position calculator 15 then calculates the position of the tool tip part in the world coordinate system of the robot 11 on the basis of the rotation angles of the motors 20 that have been read and the design dimensions of the mechanical units such as the arms 11a and the tool 11c, e.g. the lengths between motor axes. The design dimensions of the mechanical units are stored in the robot control device 10 in advance.

Next, in step S12 of FIG. 3, the determination unit 17 determines whether or not the position of the tool tip part calculated by the robot tool tip position calculator 15 is within the operation limited region A set in advance by the operation limited region setting unit 16. According to the determination that the position of the tool tip part is within the operation limited region A, step S13 of FIG. 3 is carried out.

In step S13 of FIG. 3, the operation limiting unit 18 limits at least one of the speed and the acceleration of the robot 11 to no greater than a respective predetermined value.

For example, the operation limiting unit 18 reduces only the command values for the speed and/or acceleration in the operation commands outputted from the operation commander 12 or the teaching mode commander 13 illustrated in FIG. 1 to no greater than a respective predetermined threshold value, and then outputs the reduced values to the servo amp 19. As a result, regardless of whether the robot is manufacturing or being taught, the robot 11 executes the designated operations while the speed and/or acceleration of the robot 11 is reduced to no greater than a respective predetermined safe value while the position of the tool tip part is within the operation limited region A.

On the other hand, in accordance with the determination in step S12 that the position of the tool tip part is not within the operation limited region A, neither the speed nor acceleration of the robot 11 are limited. In other words, the robot 11 is operated at the speed and acceleration designated in the operation commands outputted from the operation commander 12 or the teaching mode commander 13 (step S14 of FIG. 3).

Furthermore, when the above-described process of step S13 or step S14 is executed, it is determined whether or not an operation command complete signal has been issued (step S15 of FIG. 3). The operations of the robot 11 end upon it being determined in this step that the operation command complete signal has been issued. However, the above-described series of processes from step S11 to step S15 is repeated while it is determined that the operation command complete signal has not been issued, or in other words, while operation commands are being outputted.

As described thus far, in the case where the robot 11 is caused, for example, to attach/remove a workpiece to/from a machine tool at a manufacturing facility, a user can set a desired region containing the machine tool as the operation limited region A in the robot control device 10 in advance. The robot control device 10 is configured to calculate the position of the tool tip part of the robot 11 during manufacturing and teaching, and limit the speed and acceleration of the robot 11 while the position of the tool tip part is within the operation limited region A. Accordingly, in the case where interference arises between the machine tool and the robot 11 during manufacturing, or robot teaching due to programming error or operation error, damage can be reduced as compared to a case where neither the speed nor acceleration of the robot 11 are limited.

The robot control device 10 is furthermore configured to not limit the speed and acceleration of the robot 11 when the position of the tool tip part is not within the operation limited region A. Thus, a situation in which the speed and/or acceleration of the robot is reduced in operation regions where speed limit is unnecessary can be avoided, and the operating efficiency of the robot 11 during manufacturing or teaching is then improved.

Note that the robot control device 10 according to the above-described embodiment can be configured using a computer system including a storage unit, a control processing unit (CPU), a communication unit, and the like connected to each other by a bus. The storage unit is read-only memory (ROM), random access memory (RAM), or the like. Additionally, the functions, and operations of the above-described operation commander 12, the teaching mode commander 13, the robot tool tip position calculator 15, the operation limited region setting unit 16, the determination unit 17, the operation limiting unit 18, and the like included in the robot control device 10 can be realized by the CPU executing a program stored in the ROM.

Although the foregoing has described the present invention using a representative embodiment, it will be clear to one skilled in the art that many variations on the embodiment, as well as other modifications, omissions, and additions, can be made without departing from the scope of the present invention.

1. A robot control device configured to control a robot used in industrial fields, the device comprising:
a robot tool tip position calculator configured to calculate a position of a tip part of a tool attached to the robot while the robot is operating;
an operation limited region setting unit provided for a user to set an operation limited region having a desired size using coordinate values in a world coordinate system of the robot;
a determination unit configured to determine whether or not a position of the tip part calculated by the robot tool tip position calculator is within the operation limited region set by the operation limited region setting unit; and
an operation limiting unit configured to, in accordance with the determination unit having determined that the position of the tip part is within the operation limited region, limit at least one of a speed and an acceleration of the robot.

2. The robot control device of claim 1, wherein the robot is a robot configured to carry out a task of attaching and removing a workpiece to and from a machine tool; and
the operation limited region is a region containing the machine tool.
